(19) United States
(12) Patent Application Publication
(10) Pub. No.: US 2016/0112782 A1
(43) Pub. Date: Apr. 21, 2016

(54) ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: DONG-FENG LI, Wuhan (CN); CHING-JOU CHEN, New Taipei (TW); CHAO-CHI CHANG, New Taipei (TW); YUN-DONG XU, Wuhan (CN); CHANG-SHENG ZHOU, Wuhan (CN)

(21) Appl. No.: 14/527,216

(22) Filed: Oct. 29, 2014

(30) Foreign Application Priority Data
Oct. 17, 2014 (CN) 201410551427.0

(51) Int. Cl. H04R 1/02; H04N 5/66

(52) U.S. Cl. CPC H04R 1/025; H04N 5/66; H04R 2499/13

(57) ABSTRACT

Electronic device includes a host, a loudspeaker box secured to the host, and a display. The host includes a first connector. The display includes a second connector. The first connector extends through the loudspeaker box, and the second connector is connected to the first connector to secure to the display to the host.

### FIELD

The subject matter herein generally relates to an electronic device.

### BACKGROUND

An electronic device such as an All-In-One computer comprising a host and a display integratedly formed. The host can comprises a motherboard and a plurality of other electronic components, such as hard disk drives, a memory card, a power supply.

### BRIEF DESCRIPTION OF THE DRAWINGS

Implementations of the present technology will now be described, by way of example only, with reference to the attached figures.

FIG. 1 is an exploded, isometric view of an embodiment of an electronic device.

FIG. 2 is similar to FIG. 1, but viewed from a different angle.

FIG. 3 is an assembled view of the electronic device of FIG. 1.

FIG. 4 is an assembled view of the electronic device of FIG. 2.

FIG. 5 is an isometric view of another embodiment of the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to an electronic device. The electronic device comprises a host, a loudspeaker box secured to the host, and a display. The host comprises a first connector. The display comprises a second connector. The first connector extends through the loudspeaker box, and the second connector is connected to the first connector to secure to the display to the host.

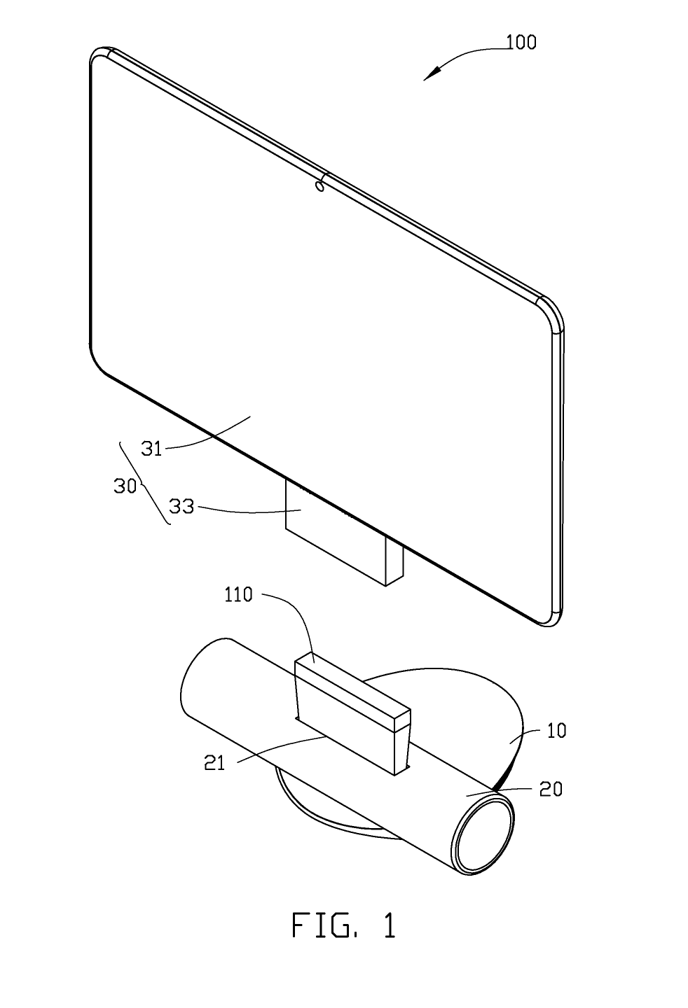

FIG. 1 illustrates an electronic device 100 from a first angle. The electronic device 100 comprises a host 10, a loudspeaker box 20 secured to the host 10, and a display 30. In at least one embodiment, the loudspeaker box 20 is integrated with the host 10, and the electronic device 100 is an All-In-One, which having a host and a display integratedly formed, with the host comprising a motherboard and a plurality of other electronic components, such as hard disk drives, a memory card, a power supply.

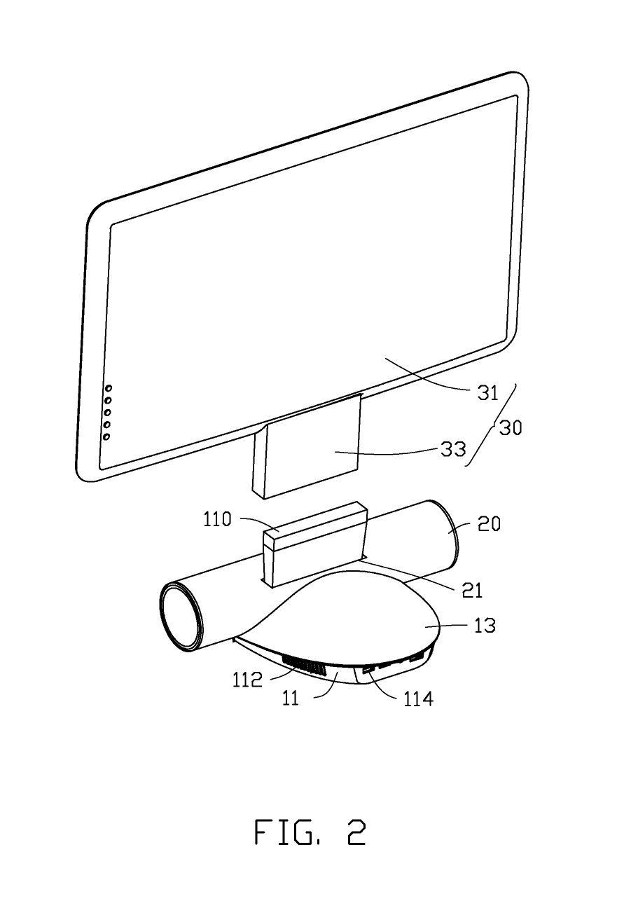

FIG. 2 illustrates an electronic device 100 from a second opposite angle. The host 10 comprises a base 11 and a cover 13 located on the base 11. The base 11 secures a first connector 110 and other electronic components (not shown) therein. The electronic components can be a motherboard, a Central Processing Unit (CPU), a power supply, a memory card, a fan, etc. A plurality of dissipating holes 112 is defined in a side portion of the base 11. A plurality of interfaces 114 is defined in a first end of the base 11, and the loudspeaker box 20 is located on a second opposite end of the base 11. The plurality of interfaces 114 can be used to connect peripheral components, such as an earphone, a mouse, a keyboard. In at least one embodiment, the cover 13 is arc-shaped and jointed to the loudspeaker box 20.

The loudspeaker box 20 is substantially cylindrical and is connected to the host 10. In at least one embodiment, the loudspeaker box 20 can be crescent or animal shaped. The loudspeaker box 20 defines a through hole 21, and the first connector 110 extends through the through hole 21 to be exposed out of the loudspeaker box 20.

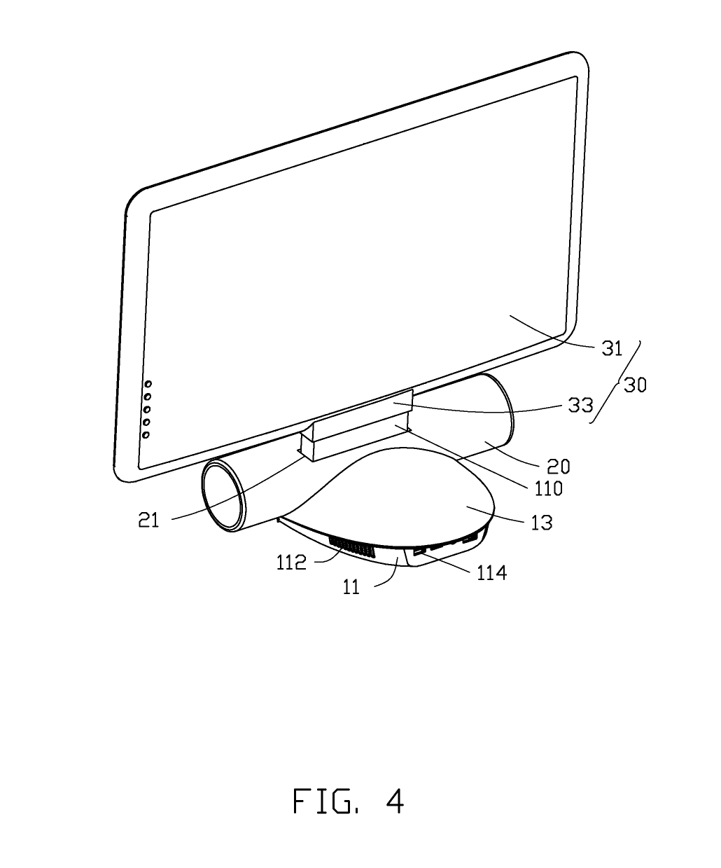

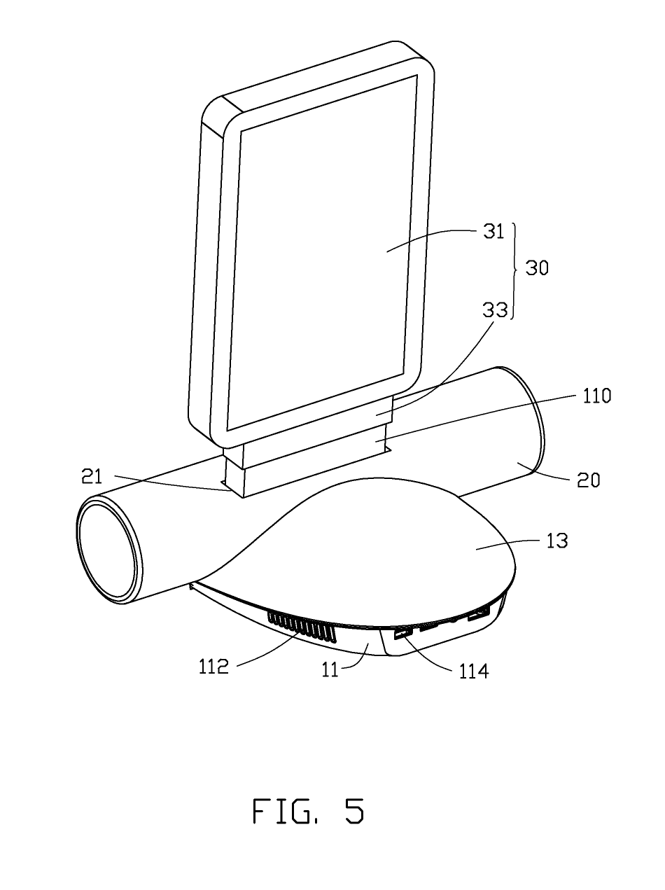

The display 30 comprises a main body 31 and a second connector 33 connected to the main body 31. In at least one embodiment, the second connector 33 can be connected to the first connector 110, so that the display 30 can be connected to the host 10. In at least one embodiment, the display 30 can be a first display of a personal computer (see FIGS. 1-4), or can be a second display of a tablet computer (see FIG. 5).

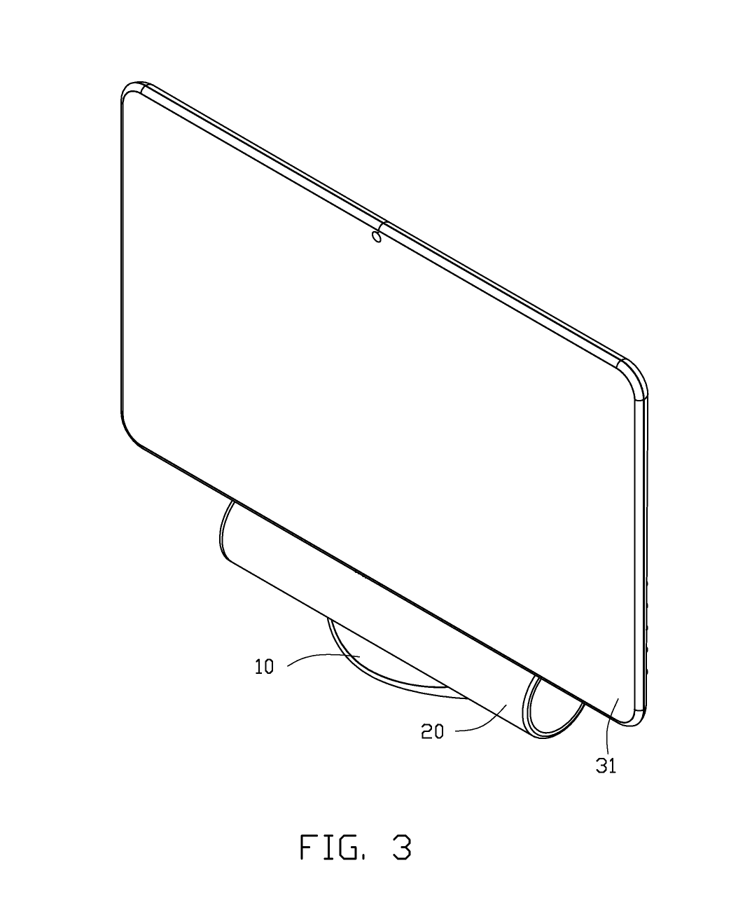

FIGS. 3-5 illustrate in use, the display 30 is moveable relative to the host 10 in a direction that is substantially perpendicular to the host 10 for allowing the first connector 110 to be received in the second connector 33, so that the second connector 33 is connected to the first connector 110 and the display 30 is connected to the host 10. In disassembly, the second connector 33 is detached from the first connector 110.

When the electronic device system needs to change or upgrade, the second connector 33 is detached from the first connector 110 to change or upgrade the host 10. When the display 30 needs to the change, the second connector 33 is detached from the first connector 110 to change the display 30.

The embodiments shown and described above are only examples. Many details are often found in the art such as the other features of a display. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device comprising:
a host comprising a first connector;
a loudspeaker box secured to the host; and
a display comprising a second connector;
wherein the first connector extends through the loudspeaker box, and the second connector is connected to the first connector to secure to the display to the host.

2. The electronic device of claim 1, wherein the loudspeaker box is integrated with the host.

3. The electronic device of claim 1, wherein a through hole is defined in the loudspeaker box, and the first connector extends through the through hole to be exposed out of the loudspeaker box.

4. The electronic device of claim 1, wherein the loudspeaker is substantially cylindrical.

5. The electronic device of claim 1, wherein the host comprises a base and a cover located on the base, the first connector is secured to the base, and the cover is jointed with the loudspeaker box.

6. The electronic device of claim 5, wherein the cover is substantially arcuate.

7. The electronic device of claim 1, wherein a plurality of interfaces is located on a first end of the base, and the loudspeaker box is located on a second opposite end of the base.

8. The electronic device of claim 1, wherein the display is a display of a personal computer, or a tablet display.

9. An electronic device comprising:
a host;
a loudspeaker box secured to the host; and
a display,
wherein the display is moveable relative to the host to electronically connect to the host, and the loudspeaker is located between the host and the display.

10. The electronic device of claim 9, wherein a through hole is defined in the loudspeaker box, the host comprises a first connector, the display comprises a second connector, the first connector extends through the through hole to be exposed out of the loudspeaker box, and the second connector is connected to the first connector to secure to the display to the host.

11. The electronic device of claim 9, wherein the loudspeaker box is integrated with the host.

12. The electronic device of claim 9, wherein the loudspeaker is substantially cylindrical.

13. The electronic device of claim 10, wherein the host comprises a base and a cover located on the base, the first connector is secured to the base, and the cover is jointed with the loudspeaker box.

14. The electronic device of claim 13, wherein the cover is substantially arcuate.

15. The electronic device of claim 9, wherein a plurality of interfaces is located on a first end of the base, and the loudspeaker box is located on a second opposite end of the base.

16. The electronic device of claim 9, wherein the display is a display of a personal computer, or a tablet display.

17. An electronic device comprising:
a host comprising a base and a first connector protruding from the base; and
a first display moveably attached to the host, and a second connector located on a bottom of the first display;
wherein the first display is moveable relative to the host in a direction that is substantially perpendicular to the base for allowing the first connector to be received in the second connector, thereby the first connector is electronically connected to the second connector to allow the host to connect the first display.

18. The electronic device of claim 17, further comprising a loudspeaker box, wherein a through hole is defined in the loudspeaker box, and the first connector extends through the through hole to be connected to the second connector.

19. The electronic device of claim 18, wherein the loudspeaker is located between the host and the display.
